(19) United States
(12) Patent Application Publication
(10) Pub. No.: US 2007/0203679 A1
(43) Pub. Date: Aug. 30, 2007

(54) Virtual prototyping system and method

(76) Inventors: Matthew Joseph Macura, Cincinnati, OH (US); Kenneth Gerard Schaub, Cincinnati, OH (US); Scott Edward Dawson, Cincinnati, OH (US); John F. Clisham, Liberty Township, OH (US); Noble Lester Rye II, Liberty Township, OH (US); Lisa M. Pence, Florence, KY (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/598,335

(22) Filed: Nov. 13, 2006

Related U.S. Application Data
(60) Provisional application No. 60/737,830, filed on Nov. 17, 2005.

(51) Int. Cl. G06F 17/50

(52) U.S. Cl. 703/1

(57) ABSTRACT

A method for modeling design of products, the method comprising: a. providing a user with a computer, the computer having software capability locally or remotely accessible to do the following: i. analyze one or more analysis inputs; ii. assemble the inputs for analysis; iii. perform a simulation analysis; iv. generate a report; b. initiating an analysis session on the computer; c. selecting one or more analysis inputs; d. assembling the analysis inputs; e. running an analysis; f. generating a report of the analysis.

### CROSS REFERENCE TO RELATED APPLICATION

This application claims the benefit of U.S. Provisional Application No. 60/737,830, filed Nov. 17, 2005.

### FIELD OF THE INVENTION

The present invention relates to a system that can be used to facilitate three-dimensional computer-aided modeling and design of products.

### BACKGROUND OF THE INVENTION

Computer simulations, e.g., finite element analysis (FEA), computational fluid dynamics (CFD), and the like, have long been used to model and predict the behavior of systems, particularly dynamic systems. Such systems use mathematical formulations to calculate behavior under various conditions based on fundamental physical properties and physics equations. Various methods are known to convert a known physical object into a grid, or mesh, for performing a simulation, and various methods are known for calculating interfacial properties, such as stress and strain in the case of FEA, at the intersection of two or more modeled physical objects.

The use of computer simulations such as computer aided modeling in the field of garment fit analysis is known. Typically, garment fit modeling involves creating a three-dimensional (hereinafter “3D”) representation of the body, such as a woman, and a garment, such as a woman's dress, and virtually representing a state of the garment when the garment is actually put on the body. Such systems typically rely on geometry considerations, and do not take into account basic physical laws. One such system is shown in U.S. Pat. No. 6,310,627, issued to Sakaguchi on Oct. 30, 2001.

3D modeling of a human body is also utilized in the field of medical device development. In such modeling systems, geometry generators and mesh generators can be used to form a virtual geometric model of an anatomical feature and a geometric model of a candidate medical device. Virtual manipulation of the modeled features can be output to stress/strain analyzers for evaluation. Such a system and method are disclosed in WO 02/29758, published Apr. 11, 2002 in the names of Whirley, et al.

The problem remains, however, that the effort required to set-up and conduct an analysis according to these methods requires expertise across several fields and usage of complicated software tools that often require years of training before an effective initial model can be created. For an individual who may be interested in designing a product by use of these methods that have been discussed, these years of training are both expensive and time-consuming, and effectively inhibit broad-based acceptance of these methods for the purposes of effectively designing products by use of these methods.

Accordingly, there remains a need for a system or method capable of reducing the training and effort required for a person interested in designing a product to use consumer simulation methods without sacrificing the benefits consistent with the above-mentioned methods, and, particularly methods that rely upon fundamental laws of physics in computer-aided simulations.

Further, there remains a need for a modeling system in which many people who are interested in designing similar products can use such modeling methods.

Furthermore, it would be desirable to have a system that minimizes the hardware and software that each individual requires to be able to use this system.

Further, considering that these individual may be present in several locations, both within the United States, and even in other countries throughout the world, it would be furthermore desirable that this system or method performs equally well from all global locations.

### SUMMARY OF THE INVENTION

A method for modeling design of products, the method comprising:
a. providing a user with a computer, the computer having software capability locally or remotely accessible to do the following:
   i. analyze one or more analysis inputs;
   ii. assemble the inputs for analysis;
   iii. perform a simulation analysis;
   iv. generate a report;
b. initiating an analysis session on the computer;
c. selecting one or more analysis inputs;
d. assembling the analysis inputs;
e. running an analysis;
f. generating a report of the analysis.

### BRIEF DESCRIPTION OF THE DRAWINGS

FIG. 1 is a flow chart representation of an embodiment of the invention.

FIG. 2 is a flow chart representation of an embodiment of the invention.

FIG. 3 is a flow chart representation of an embodiment of the invention.

FIG. 4 is a screen shot example of a portion of the invention.

FIG. 5 is a screen shot example of a portion of the invention.

FIG. 6 is a screen shot example of a portion of the invention.

FIG. 7 is an example of a contact file for use in the present invention.

FIG. 8 is an example of an input deck for use in modeling a garment to be worn.

### DETAILED DESCRIPTION OF THE INVENTION

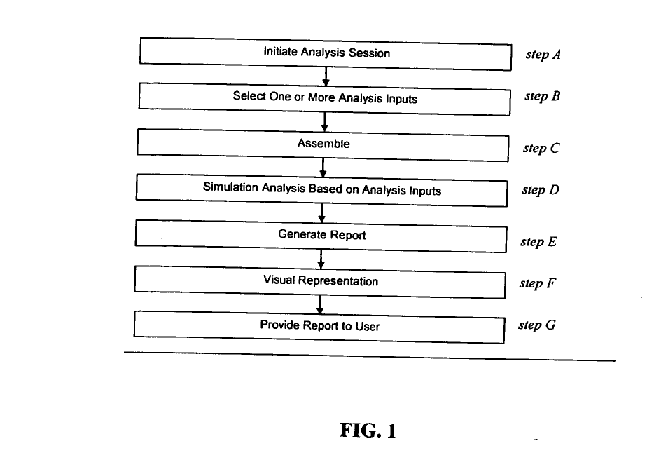

The invention can be understood by following the steps discussed below in conjunction with the flowchart in FIG. 1. The flowchart of FIG. 1 depicts elements associated with the method of the invention, starting with step A which is initiating an analysis session. Initiating an analysis session can be achieved by launching a software program that runs on a computer in which the user directly interacts through input devices such as a mouse, keyboard, voice command, or any other of known input devices. This software may run entirely locally on the user's computer, or the software may be a client software whose purpose is to facilitate communication with another computer, often called a host computer. A host computer may be a remote unit located anywhere in the world and can be connected to through commonly known methods of computer networking. In cases involving a remote host computer, the client computer may alternatively be called a local computer. In this context, a remote computer can be thought of as any computer which is not the local computer. Often, the remote computer of interest may be the host computer, but it could alternatively be a different computer that may be associated with either the local computer or host computer through known computer networking techniques.

In one embodiment the method of the present invention operates in a web-based environment, such as by the internet. For web-based use, the user can open an internet web browser such as Internet Explorer (Microsoft Corporation, Redmond, Wash.) or Netscape (Netscape Communications, Mountain View, Calif.), within step A of initiating an analysis session. Once the browser opens, the user can type in the appropriate uniform resource locator (URL) or internet protocol (IP) address to access information, pre-constructed inputs, and internet links to relevant tools for simulation and analysis by the present invention.

Alternatively, to initiate an analysis session a URL or IP address can initiate a software application that can be launched on the local computer, either in a process of downloading and launching software to the local computer, or by launching software currently resident on the local computer. One example includes using a technique known in the art as client-server which executes software on the local workstation, known as a client, which enables a connection to a remote computer, called a server, in which processing is shared and communication between the two computers is efficiently managed. Another example includes using a technique known in the art as Web Services which executes software through the web browser and can send requests as standard Extensible Markup Language (XML) documents to other programs using the Web Services. Examples of this approach include simple object access protocol (SOAP) and web service definition language (WSDL). This technique also can execute software on the local computer in addition to the software on the web server.

Another example includes using a terminal emulation tool such as Reflection (AttachmateWRQ Worldwide, Seattle, Wash.) or Exceed,(Hummingbird Limited, Toronto, Ontario, Canada). In this case the terminal emulation tool can be used to connect via the network to a server where the user can interact with the application through a series of preconstructed scripts and Unix or Linux commands.

In one embodiment, one could use a software tool like Enterprise Accessible Software Applications (EASA) (AEA Technology, Pittsburgh, Pa.). With EASA, the user can select to initiate an analysis session from a series of potentially available analysis session options in which the decision is based upon the subsequent analysis to be performed based upon the parameters and analysis options chosen. In this embodiment, the user could click on an appropriately labeled link, such as a “Simulation & Analysis Tools” text link on an internet or intranet site. This could then connect the user through the network to a selection page running on a web server. From this display the user can select a simulation analysis application to execute. To make a selection the user could click on a graphic or on text corresponding to a particular simulation analysis to run. In one example relating to a model for analyzing garment fit, an application called “Bodyfit application” could be selected.

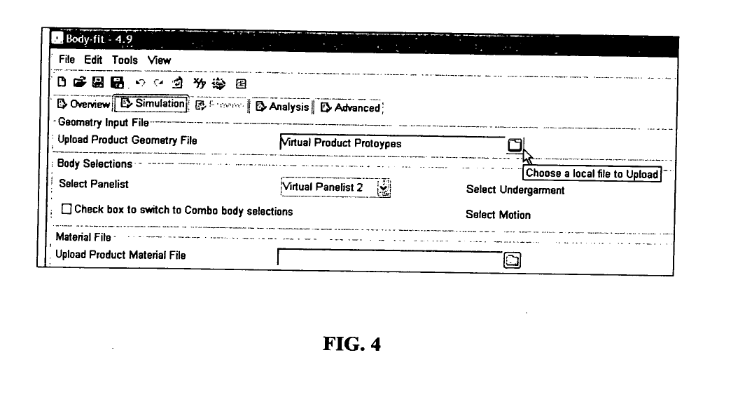

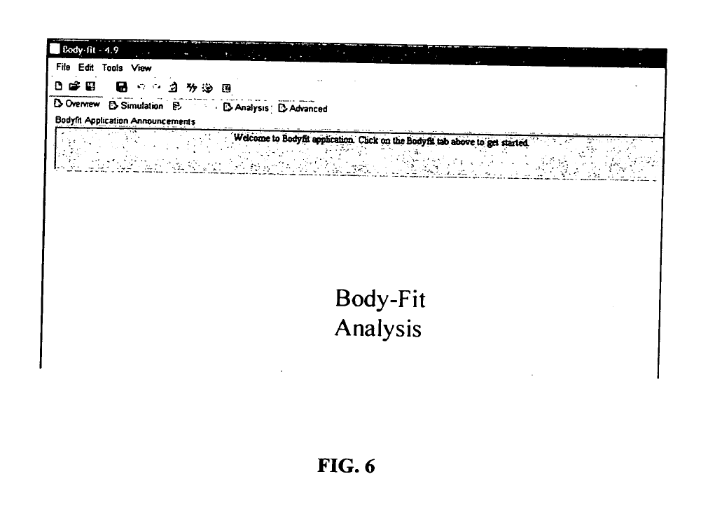

Having completed step A of initiating an analysis session, but before proceeding to the step B as labeled in FIG. 1 of selecting an analysis input, several user information options can be made available. In one embodiment, the first displayed page of the initiated analysis session can be called the Overview tab as shown in FIG. 6, and can be used to display an application logo, announcement information, help information, links to additional help documents, animations, or any other such informative means. Such information could be used to educate an individual user, provide information on any recent changes to the analysis session, or provide analysis session help on how to better perform subsequent steps. It is also envisioned in this embodiment that various additional tabs such as Simulation, Preview, Analysis and Advanced tabs, also shown in FIG. 6, can be shown in addition to the Overview tab. It is possible that some of the tabs may be activated while other tabs may be de-activated for selection as part of the design. Typically, for clarity of use, it is desired that only tabs that are relevant to the user at this point in the selected analysis session are activated. In one embodiment, at this stage of the process the user can only select from Simulation, Analysis or Advanced tabs. To initiate a new analysis session the user can point to the appropriate tab, such as the Simulation tab, by way of using the mouse and selecting by clicking. Once the Simulation tab has been selected via a mouse click, the simulation analysis input screen will be displayed as shown in FIG. 4. Alternatively, it is also possible that such an Overview tab is not presented, and instead, upon initiating the analysis session, the user immediately proceeds into step B of FIG. 1 of selecting one or more analysis inputs.

Having initiated an analysis session, the next step as labeled by step B can be to select one or more analysis inputs, as shown in the flow chart of FIG. 1. Analysis inputs can be understood as information provided by a user during an analysis session through which the user provides the specific attributes for a simulation analysis that describe the specific condition they wish to conduct to evaluate a virtual product in a virtual condition. For example, while an initiated analysis session can be developed to consider the application of a garment to a body, the analysis inputs are provided so as to specifically define the geometry of a body, the specific geometry and material properties of the garment to be virtually worn on the body, the motion the body will undergo, and the subsequent analysis that will be conducted to evaluate the garment performance upon completion of the simulation analysis.

Analysis inputs can be pre-constructed, or interactively constructed, or a combination of pre-constructed and interactively constructed.

Pre-constructed inputs are inputs that exist prior to initiating the analysis session, and are selected during the analysis session. Examples of pre-constructed inputs include files stored on a remote computer, files stored on a local computer, scripts or programs that are executed on a remote computer, scripts or programs that are executed on a local computer, among other such examples.

Interactively constructed inputs are inputs that can be created by a user during or as part of the analysis session once the analysis session has been initiated. Examples of interactively constructed inputs include creating or executing commands on at least a portion of a file during an analysis session. During an analysis session, a user could be asked to supply the system with a particular file that perhaps might describe the material properties of at least a portion of one of the components in the analysis, and could be asked to supply this information in an interactive nature by asking the user to interactively provide information required in this material property file.

An input that is a combination of pre-constructed and interactively constructed can be when at least a portion of the analysis input is pre-constructed and exists prior to initiating the analysis session, and at least a portion of the analysis input is created during the analysis session. One such example would be to have a pre-constructed file that includes variables. During the analysis session, the user can then make selections that update variable values that would be substituted into these pre-constructed files to provide user interactivity. In one embodiment, this combination of pre-constructed inputs combined with interactively constructed inputs could use variable value substitution capability such as provided in EASA. In another embodiment, the user may directly provide these variables, or could even directly edit the files interactively to change these values.

In one example for selecting a pre-constructed analysis input for modeling a garment to be worn on a body, the user can supply input files related to the geometry of a product in which the file resides locally on a computer. Using capabilities that exist within EASA, one can use the capability to “Upload a file” in which a dialogue is used to select this file from the local computer that is desired to be used for the geometry of a product. This approach could obviously be re-applied as necessary to select at least one or more pre-constructed inputs that reside on the local computer prior to analysis. An obvious extension of this capability is that instead of these files residing on the local computer, they could reside on a remote computer. Using technologies known in the art, communication across computers for the purposes of storage and selection of files across multiple computers is well known, and capabilities readily exist so as to directly apply these technologies to select at least one or more pre-constructed inputs as a file on a remote computer.

In another example for selecting a pre-constructed analysis input, the user can make a selection from a list. In this case, a list may take many different forms, including a pull-down menu, a radio button, checkboxes, among other options. In this example, among other options, these lists can be programmed directly in the application, or created for by the application during the initiated analysis session by extracting information from a file or by structured queried language (SQL) calls to a database such as a relational database. Furthermore, it is possible that these lists can be generated based on selections made from previous lists by the user. In one such example for performing virtual fit analysis of a garment to be worn on a body, a list of preconstructed bodies can be presented and upon selection from the list, a list of preconstructed garments relevant to the selected body can be generated and displayed. In this example, the selection can be related to a file selection within the application from a database or directory of files on a remote computer.

Another example of an analysis input uses a range selector, such as by use of what is called a “slider” where the selection can be a number from a predetermined range that is chosen by clicking and holding the mouse button on a slider bar image and then moved back and forth until the desired number is chosen. Once the mouse button is released, the position of the slider bar determines the selection which is captured and used in the application. Capabilities readily exist within EASA to perform such an operation. In one embodiment, using such a range selector can be used in an operation that will be subsequently performed in a subsequent assembly step, as discussed below. For example, this could correlate to the selection of a file on a remote computer, this could correlate to a file operation that will be performed by a script, or possibly even a variable that will be operated within a script on a file, among other such possibilities. In another example, a range selection could correlate to data to be tracked concerning the analysis. For example, one could have the user select the location from which they are performing this analysis so as to subsequently track statistics on where analyses are being performed and in which frequency. Text data can also be provided through a data field called a “textbox” for purposes of documenting the simulation in language relevant to the submitter.

In another example for choosing a pre-constructed input, one could also select a series of inputs such as could be represented in making a selection from a database with more than one data field. One could use the application selections to generate SQL calls which are then transmitted to a database where selections are made based on the SQL parameters, then returned to the requester. One such example could be the selection of a preconstructed body from a list which is then used to determine the selection options for a garment style and motion options as well as provide parameters for use in subsequent steps. One embodiment could use a series of data fields in the database to set default values as a starting point for simulation analysis, which could then be modified through the application dialog as needed.

In some embodiments, in selecting an analysis input, one can choose to include or not include an analysis input. For example, it is possible that in some cases, portions of the analysis can be considered optional. These optional analysis inputs can be included by an approach in which the user is presented to select an analysis input, but can alternatively choose to not include that analysis input. For example, it may be desirable to include a file in the analysis of a garment on a body that can measure the forces at an interface within the product. While some users might tend to not consider including such an option, in the circumstance in which including this option is desirable, a checkbox or radio button could be used to toggle the selection on and off. It could also be possible that the user has created a file or modified an existing file to further customize the simulation. In one example, a customized motion file could be created and then through the input selection process using the drop down list for motion files, “Upload File” could be selected. In this case the selection of “Upload File” causes the application to dynamically update the user's display so as to include an upload file selection button to enable the look up of a file on the local or remote computer. Once selected, this file can then be uploaded to the application where it is used in place of a pre-constructed input.

Another example of selecting an analysis input can be to interactively construct inputs, such as those that can be used to create a file storage directory. In conducting an analysis, file storage can be a critical factor to be considered. In some cases, storing the files on a local computer is desirable. In other cases, when a simulation analysis is run on a remote computer or server, file storage can be structured in a way that is relevant and valid on that remote server. The file structure on each remote server can be determined by the security and access rules for that server and perhaps the application must understand the security and access rules for each server where it is desired to create directories and files and apply those rules as needed. Also, the directories and files can be created in a way such that subsequent simulations do not overwrite, replace or erase directories or files. In one example, inputs that are selected are used to construct the directory name and server timestamps are used to create a unique directory name.

One way in which directories can be interactively constructed during the analysis session is to access the computer that the files will be stored upon, and interactively create the directory or file structure that can be used to store the files by tools that are readily available and by means well known in the art. Another way in which these directories could be constructed is the directory structure could be created in advance and then an empty directory could be chosen during the simulation and analysis run.

Another example of selecting an analysis input that includes some interaction is to provide variable values or commands that can subsequently be used within a script. One such example of this approach is to use a variable substitution, such as is readily available in a suitable software package such as EASA. The scripts that are interactively modified could include scripts used to manipulate files during the assembly step. The scripts that are interactively modified could include scripts used to manipulate files during the analysis results step. The scripts that are interactively modified could include scripts used to manipulate files during the report step.

Another example of selecting an analysis input that can include some interaction is to issue a command within a pre-processing software that can be run locally, remotely, as part of the existing initiated analysis session, in conjunction with the initiated analysis session, independent of the initiated analysis session, across a client session, among other possible ways to run such a software. By issuing these commands through an analysis session, these commands are considered to be analysis inputs. One example is to use a software tool such as ABAQUS CAE (ABAQUS Inc., Pawtucket R.I.) in which commands can be issued for the purposes of supplying analysis inputs. Another example is initiating a GO-GLOBAL session (GraphOn Corporation, Santa Cruz, Calif.) which can communicate a session of a pre-processor, such as ABAQUS CAE, Hypermesh (Altair Engineering, Troy, Mich.), GAMBIT (Fluent Inc, Lebanon, N.H.), or any other such pre-processing software.

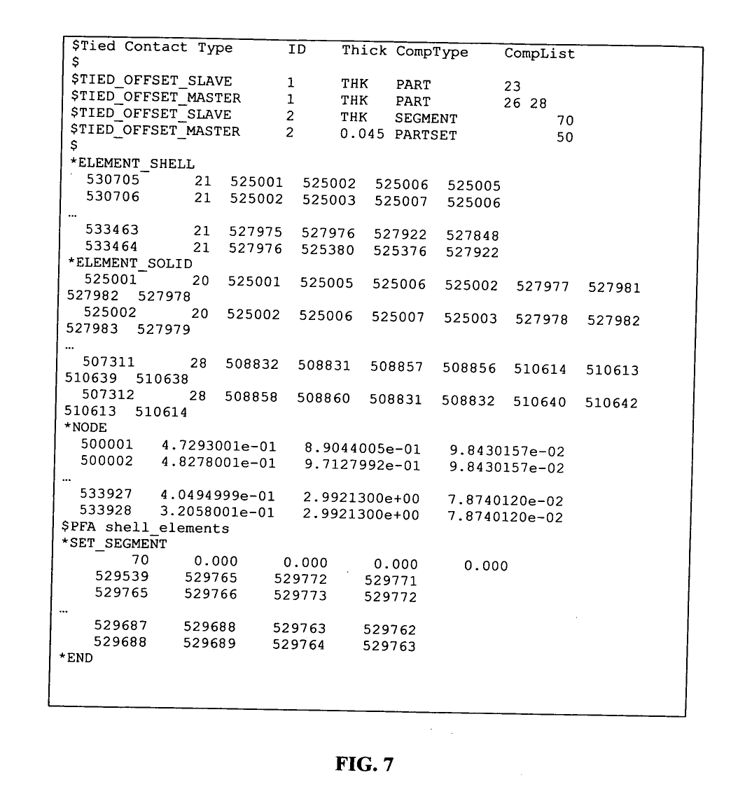

Another example of selecting an analysis input that includes some interaction is to embed information within a previous selection that will in turn provide an analysis input. In one such example, when a file is selected from a local computer, such as for the geometry of a product of interest, one can embed information in the top of this file that will subsequently generate a file in the assembly step. When one considers a simulation of a garment to be worn on a body, this technique can be used to a particular advantage to generate a contact file for how the product or garment interacts with itself and the body, as often contact files are complex and dependent upon the full and specific list of parts that exist within a given product geometry. An example of such embedded information to generate a contact file can be seen in FIG. 7.

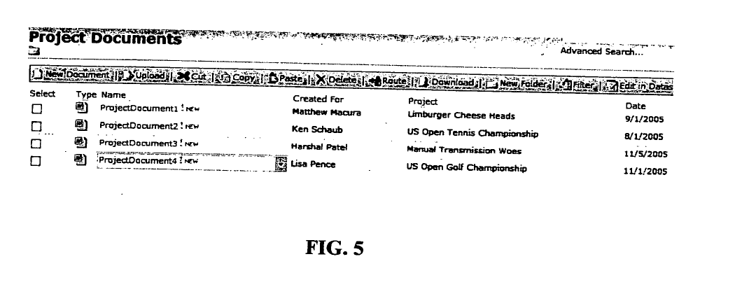

In one embodiment, during or before initiating the analysis session, one can consider an optional step of acquiring at least a portion of some of the analysis inputs that will need to be provided. Such files can be acquired by downloading from a remote computer, by receiving in e-mail, by connecting to a remote server (known as mapping a remote network drive), or by acquiring the file via media such as floppy disk, memory sticks, or the like. Alternatively, operations can be performed by someone other than the individual user, perhaps by an automated system, and can alternatively be performed to acquire at least a portion of one of the analysis inputs and place on a remote computer. In one embodiment, a file containing information related to the geometry of a product of interest can be acquired by a user to be used as an analysis input to a simulation analysis. One way in which this can be achieved is by connecting to a database of geometry files for direct input to the simulation analysis, or by acquiring the geometry file to an intermediary repository for reference or manipulation. To acquire a geometry file for storage on an intermediary repository, a user can click on a hyperlink, such as an internet link, to connect to the data repository server where he could locate and download a geometry file. In one embodiment, this could result in the display of a list of geometry files with descriptive information about those files for the user to use as a reference in identifying the geometry file of interest. The user could then invoke a file transfer mechanism known in the art as file transfer protocol (FTP) to copy the file to the intermediary repository. One embodiment could use a tool like Microsoft Sharepoint (Microsoft Corporation, Redmond, Wash.) as the repository with custom file attribute data as shown in FIG. 5. In this embodiment the user could click on a selection arrow for the desired geometry file and choose an option such as “Download” from the list of options. The download process could then prompt a user for a location to store the selected geometry file using a standard Windows “Save As” input box. Once the location has been selected, the user can click on the Save button and the file is saved to that location for later use in the simulation analysis. A similar process can be considered for other additional analysis inputs as appropriate.

While many examples are provided, it is understood that still other possible examples exist to select analysis inputs by means of selecting a pre-constructed analysis input, interactive constructing an analysis input, or a combination of pre-constructed analysis with interactively constructing. Therefore, the examples above are not to be considered limiting, but illustrative of this portion of the method of the present invention. It should also be understood that in some embodiments of the invention, it could be that a combination of techniques to select analysis inputs can be applied as appropriate.

Once the analysis inputs have been selected, as shown in step B of FIG. 1, analysis inputs can be assembled to construct the desired analysis as indicated by Step C. The assembly step can be best understood as executing operations that have been specified in conjunction with the selected analysis inputs to combine, move, copy, modify, and/or generate files that will be required to perform a subsequent analysis step. The output of the assembly step is at least one or more files that constitute the information required to perform a simulation analysis, commonly known in the art as an input deck. In one embodiment, the selection of all analysis inputs is complete before beginning the step of assembly or any other subsequent steps. By doing so one can minimize the communication of information, especially when a user computer and a remote computer will execute the operations exist in a different locations such as in different countries. Minimization of communication across a network is a way in which more equivalent system performance can be achieved regardless of the user computer location.

Alternatively, only at least a portion of the analysis inputs can be specified prior to conducting at least a portion of the assembly operations. Also, a portion of some subsequent steps are also conducted prior to specifying at least a portion of the remainder of the analysis inputs, and conducting at least a portion of the remaining subsequent steps. One example can be that a user could specify the analysis inputs relating to the simulation analysis to be conducted, and then the assembly and simulation analysis steps are conducted. Before the user provides additional analysis inputs required for the subsequent steps of generating the report in which the user is able to post-process the simulation analysis to understand results.

While at least portions of the assembly step can be made on the user computer, on a remote computer, or across a combination of potentially several local and remote computers, in one embodiment, the assembly step is made on a remote computer in a designated location. In this embodiment, by performing these operations on a remote computer, the software, scripts, and steps that will be performed in the assembly step need only be installed, tested, and verified on one or a few computers. It should also be understood that in using a remote computer, it might be advantageous to perform other operations on a computer that is directly connected to this remote computer. In one such example, the remote computer can be an EASA server, and using capabilities resident within EASA, at least one or more directly connected computers upon which certain operations can be performed can be set-up and considered to be EASA computer servers.

During the assembly step, a series of assembly operations can be performed that in combination comprise the assembly steps. Assembly operations are the individual commands executed in order to complete the assembly step. Many examples of assembly operations exist including linking, combining, moving, copying, modifying, deleting, and generating files, directories, and file attributes.

In one example of an assembly operation, files can be copied from, to, or within at least one or more remote and/or local computers by means commonly known in the art. In one example an application on the local computer can invoke a program that uses FTP to transmit a file from the local computer to a remote computer where it is stored by the remote computer for use in subsequent steps. In another example, FTP could be used to transfer a file from a remote computer to a local computer. In another example, a file may be copied from one directory on a remote computer into a new directory on the remote computer. In another example, a file may be copied from one remote computer to a different remote computer. It is possible that the location of files may have been provided as an analysis input, either by the user choosing the file location directly, or by having provided an analysis input as a selection from a list as described previously, and that selection could be related to a file location through the analysis session. Similar options also exist for the copying of directories.

In another example of an assembly operation, files can be combined by means commonly known in the art. Similar to an assembly operation of copying, files can be combined from a variety of files potentially located on local and/or remote computers, and the combined file may reside on either a local or remote computer. Similar approaches to copying can be applied to determine the location of files to be combined. Similar options exist for the combining of directories and the contents of directories.

In another example of an assembly operation, files can be moved by means commonly known in the art. Similar to an assembly operation of copying, files may be moved from a variety of files potentially located on local and/or remote computers, and the moved file may reside on either a local or remote computer. Similar approaches to copying can be applied to determine the location of files to be moved. Similar options exist for the moving of directories.

In another example of an assembly operation, files can be split or partitioned by means commonly known in the art. Similar to an assembly operation of copying, files may be split or partitioned from a variety of files potentially located on local and/or remote computers, and the split or partitioned files may reside on a local computer, remote computer, or combination of local and remote computers. Similar approaches to copying can be applied to determine the location of files to be combined. Similar options exist for the combining of directories & the contents of directories.

In another example of an assembly operation, files can be modified by means commonly known in the art. There are many ways that files can be modified. The contents of a file can be edited, such as change portions of the file to reflect changes in material properties to nodal coordinates (positions in space). Parts of a file can be deleted, such as removing parts that are not required during a particular simulation analysis. File attributes can be changed so as to allow conversion of file formats going from one operating system to another, or file access permissions. Files formats can be converted, such as from ASCII to binary, from compressed to uncompressed, or between formats of files required as inputs to simulation analysis software. File formats can also be converted from a format of a file not directly designed as an input to simulation analysis software, such as a stereolithography file (STL) into a format of a file required as input to simulation analysis software. In some cases, these file modifications can be done by scripts or programs that can read in a file, and output a file in a modified format. Files may be modified from a variety of files potentially located on local and/or remote computers, and the modified files may reside on a local computer, remote computer, or combination of local and remote computers. Similar approaches to copying can be applied to determine the location of files to be modified.

Another example in which a file can be modified would be to change the unit of measure used such that the units are relevant for different country locations where standards of measure may differ. For example, the unit of measure chosen to convert a selected distance moved can be converted to units expected by the program so as to ensure consistent results regardless of the unit of measure selected. In one example where an analysis input requests to move a product in relation to a body, a script can be generated based on the inputs selected where commands are modified using variables and then launched on the remote server to modify the input files.

In another example of an assembly operation, files can be generated by means commonly known in the art. For example, programs can be run to create a file based on information provided as analysis inputs. Scripts can be used to create a file based on the status of the computer at that time. It is possible that in generating a file, that portions of the file may refer to other files, potentially located on that remote computer, potentially located in the same directory, potentially located on a different remote computer, or even potentially located on the user computer, and that in referring to these files, it is possible to also include information resident in these files. In one example, embedded information in a file can be used to generate a file. In one such example a contact file can be generated by a script based on the parameters selected, for example, using embedded information such as shown in FIG. 7. The information embedded in FIG. 7 is done so in such a way that while the information can be read by a script designed to generate a file from this information, it is in a format such that the simulation analysis software can not detect this information and it does not interfere in subsequent steps. Alternatively, imbedded information might be taken directly from the files themselves, and can include, for example, developing a list of parts from a full list of parts that are described in a particular file. In one example for simulating a product to be worn on a body, the location of the product in relation to the body can be modified through a selection, e.g., via a radio button, to indicate the direction of movement and through an input box to indicate the distance to be moved.

In some cases, a pre-constructed analysis input as a series of inputs such as could be represented in making a selection from a database with at least one or more data fields could be used to provide information on multiple inputs that can be used by multiple assembly operations. Assembly operations such as have been previously described could be executed in any combination as related to at least a portion of some of the database entries, allowing for the potential for multiple, related, or unrelated operations to be performed based upon a single selection of an analysis input. For an individual using this system, this feature provides the opportunity for improved efficiency in using the system, as a single analysis input selection can be used to execute a series of assembly operations such as transferring several files, or transferring and modifying files, and it need not be that each assembly step must correlate one-to-one with a selected analysis input.

In another assembly example, it is also desirable that a selected analysis input could be chosen to include or not include an analysis input. This is one way in which portions of an simulation analysis which are known to sometime be considered optional can be incorporated into the process. For example, additional files outside of the typical preconstructed inputs can be incorporated into the application by clicking the checkbox to add files on an indicated tab, such as a tab labeled “Advanced”. In this case, for each additional file selected FTP can be invoked to transmit the file to the remote server into the file directory structure created for the selected simulation.

It is also possible that assembly operations need not be related to any of the selected analysis inputs. Such assembly operations can be considered inherent to the system. For example, since it is possible that the files being copied to a remote computer may have been created on several different computer platforms, one can add an assembly step that will convert the file format to the file format of that required by the remote computer that will operate in the subsequent steps on the remote computer.

It should also be understood that in some embodiments, it is very likely that a combination of techniques to assemble could be applied as appropriate.

Once all the assembly operations are complete as indicated in step C of FIG. 1, there can be at least one or more files the contents of which provide the information required to perform at least one simulation analysis, commonly known in the art as an input deck. The information that can be resident in these files has been discussed previously in the art. For methods of simulation analysis for simulating a garment to be worn on a body, for example, see U.S. Ser. No. 11/071920, entitled SYSTEM AND METHOD OF VIRTUAL REPRESENTATION OF THIN FLEXIBLE MATERIALS, filed 4 Mar. 2005; U.S. Ser. No. 11/072047, entitled SYSTEM AND METHOD OF VIRTUAL REPRESENTATION OF FOLDS AND PLEATS, filed 4 Mar. 2005; U.S. Ser. No. 11/071917, entitled METHOD TO QUANTITATIVELY ANALYZE A MODEL, filed 4 Mar. 2005; U.S. Ser. No. 11/071919, entitled SYSTEM AND METHOD OF VIRTUAL MODELING OF THIN MATERIALS, filed 4 Mar. 2005; US 11/072152, entitled METHOD OF ANALYSIS OF COMFORT FOR VIRTUAL PROTOTYPING SYSTEM, filed 4 Mar. 2005.

It is also possible that the analysis inputs and assembly operations can be performed in such a way so as to be able to conduct more than one simulation analysis. These simulation analyses can be considered related, or potentially unrelated to each other, and may include a designed experiment.

Having completed the assembly step C of FIG. 1, and having at least one or more files that constitute the information required to perform an analysis, an analysis can be run. In one embodiment, the analysis can be a simulation analysis, as shown in step D of FIG. 1. Appropriate simulation software can be selected to run a particular simulation analysis for a given input deck. For example, an input deck for an ABAQUS (ABAQUS Inc, Pawtucket, R.I.) structural analysis simulation could be run by launching the ABAQUS software using the input deck that has been created by the above mentioned steps of the process of the current invention. In another example, an input deck for a Fluent (Fluent Inc., Lebanon, N.H.) computational flow dynamics simulation could be run by launching the Fluent software using the input deck.

Simulation analysis, as the term is used herein, refers to the act of using computational, first-principle physics-based software to solve a defined problem with capabilities inherent in that software. Simulation analysis can be executed in several different ways and can run on one or multiple computing resources using different types of simulation software for the simulation analysis. In one embodiment, simulation analysis is achieved using LS-DYNA (LSTC, Livermore, Calif.) simulation software for the simulation. Simulations can be run automatically for a user by selecting a run simulation option from a user interface, which could use a script in the background to execute the simulation. In such a case, all input files can be copied to the directory where the software is executed. One such example may be the user's directory on a computer or computer system where the simulation is being executed, or in a directory connected via the network. Alternatively, the simulation can be run using a script, or it can be run manually by the user from a computer command line interface. In such an instance, the user would be responsible to ensure all inputs were in the proper location. In one embodiment, a script is used to run the simulation analysis on a remote computer, and this script is executed through the EASA system by capabilities provided by this software. Alternatively, the simulation analysis can be directly conducted on a remote computer, previously described as the EASA server. The simulation analysis can also be submitted to run on a computer connected to the EASA server, previously described as the EASA compute server.

A simulation analysis can also be run on a remote computer through an interactive shell, a script, a script to run the job in batch, or even through job manager software such as Load Sharing Facility (LSF) (Platform Computing Inc., Markham, Ontario, Canada). In one embodiment a script is generated and launched on the remote server previously described as the EASA server where the commands are executed to submit a job to a remote job manager for dispatch on any one of a number of servers managed by that job scheduler. An additional set of commands can then be executed to monitor the progress of the job running via the job scheduler so as to execute additional steps once the initial job has completed.

During the process of the simulation analysis, several simulation output files can be generated as output of the simulation software. Simulation software inherently allows for options for a variety of additional output files, or additional content in these outputs files can be generated. The simulation outputs can consist of many different files depending on the analysis inputs. Some examples of these files include image files, text files, movie files, or binary files among other such potential output files.

Once the simulation analysis as indicated as step D in FIG. 1 is complete, the outputs from the simulation analysis can be used to generate a report, as shown in FIG. 1 as Step E. One such example of software used for generating portions of the report is LsPrepost (LSTC, Livermore, Calif.). Execution of this software can be automated, automated to run in batch, or used to run interactively. Additionally, the software can be run manually by a user interactively, or launched by a user to run in batch mode. In one embodiment, the execution of the report generation can be automated using LsPrepost software to run in batch mode using the LS-DYNA d3plot output file or series of d3plot output files as input. In this case LsPrepost can output several different image files, the number of files depending on the inputs. Image files can be in different file formats, and can, for example, include file types such as portable network graphics (PNG) and joint photographic experts group (JPG), as well as other image file types. The number of image files generated depends on the inputs. Each of these image files can be a part of the generated report.

Analysis input variables can also be used as substitutions for values within scripts, as substitutions for variables used in commands issued by the software at the system command prompt, as substitutions for variables used in subsequent post processing steps, among other such possible uses as substitutions for variables. One such way variable substitution can be accomplished is by extracting data from a database or file and replacing the value of a variable based on the data contents. For example, for some software application packages input variable values can be replaced at the time of execution by calling a specific replacement routine. This replacement routine updates the values of the variables as a first step when linked with a process step to ensure that variable substitution can take place just-in-time for processing for a particular step or event. Variable values can also be set from one value to another based on the occurrence of an event by using logical expressions to determine what value the variable should have at a particular point in time for further processing or reporting. Analysis input variables can also be used in the generation of the visual report. For example, input variables that contain information about the specific values chosen as analysis inputs can be later extracted and used in the visual report to indicate as a quick reference to what inputs were used for a particular simulation analysis.

Other such software can also be used to generate a report, including ABAQUS Viewer (ABAQUS Inc., Pawtucket R.I.), Fieldview (Intelligent Light, Rutherford, N.J.), and EnSight (Computational Engineering International, Apex, N.C.), among other such software, including customized software written especially for such purposes. It is understood by those skilled in the art that in order to use particular software to generate a report, it is required that the report generation software be compatible to read the data in the file format that has been created in the simulation analysis. For example, it is readily recognized that the d3plot files generated by the LS-DYNA simulation analysis software cannot readily be read by ABAQUS Viewer in the current commercially available version.

Alternatively, it is also possible that the simulation outputs can be directly used to evaluate numerical quantities outputted during the simulation analysis, or to plot numerical quantities in a graphical representation.

In one embodiment in which at least some image files are generated, the image files can also be used as inputs to other report generating programs. In one example, some of the image files can be used as inputs to quantitative image analysis report generation. For example, Matlab software (The Mathworks, Natick, Mass.) can be used for the quantitative analysis report generation by using several of the output image files created in the prior step as input. One way in which Matlab can be used for quantitative image analysis has been taught in WO 2005/088487, published 22 Sep. 2005. Quantitative analysis results can be stored in files that are co-located with the analysis output and other report generation files. Generated reports can be saved in the user's directory on a remote computer, or can be saved to a web server repository or can be saved to a database that can be on a remote computer by methods known in the art.

Generated reports can consist of several different types of files in combination, for example, reports may include images, charts, text documents, or other types of information. Alternatively, portions of the report can be generated interactively by using interactive versions of the simulation post processor software like LsPrepost or ABAQUS.

Having completed the report generation, the method proceeds to step F in FIG. 1 of the process in which a visual representation of report images can optionally be provided in two-dimensional and/or three-dimensional formats. For example, a three-dimensional visual representation of at least a portion of a generated report can be made using software tools known in the art as virtual reality modeling language (VRML) viewers in conjunction with files in the VRML format. These software packages may reside on the user's workstation, or may be available on a remote system via the network.

It is possible to generate visual output in many different methods. One such method that can be employed is using built-in functionality within software applications to extract data from the generated report output files. In this example, the generated report output files can be copied back to the visual report generation software and the application can extract data into pre-determined report syntax variables and generate a visual report. One such method includes using HTML formatting to provide a table of all input variable selections as part of the visual report. Functionality also exists to add additional text labels to further describe the data. Data can be presented visually in several different formats by utilizing some of the built-in visual report generation functionality within the software applications. Some of the possible data representations include tabulated formats, text, data formatted using HTML, images such as JPG and PNG, 2D line and/or contour graphs. EASA is one example of a software application that has visual report generation capability.

In step G of the process, as shown in FIG. 1, a report as generated in step E and optionally with visual representation from step F can be optionally provided to users via several different means. While the report can be generated in step E, the report may not be necessarily generated by the user interactively or on the local computer, and in these cases, the user may not be aware of the information generated in the report. Thus, in these cases, there can be a way to provide a report to the user that the user can use to be able to understand the results of the simulation analysis. For example, a generated report can be provided to a user via email. Alternatively, the email can be a notification that a generated report is available, with a link (e.g., a hyper link) to where the report is located. Alternatively, a link can be provided to an intranet website, or database, or other such computer storage location where the user can view, download, or print the report. Alternatively, the user can, if desired, retrieve a report from within a storage location. One example of such a location is provided by the EASA system, which can be accessed from a web browser. The report storage means can provide for report download options, so a user can download the report to their personal workstation. Provided reports can also include a print option so a hardcopy of the report is available if users desire. Alternatively, other means for providing the user a report can also include having a report printed, having a report printed and mailed to the user, accessing the report as a file on a remote computer, saving the report as a file on the local computer, among other such methods in which the user is provided a report.

The process as described above can provide the optional benefit of permitting a user to conduct a large series of simulations while minimizing the effort required to set-up and conduct each simulation, and minimizing the effort that will be required to learn how to conduct a simulation that is within the series of simulations to be conducted. Further, the described embodiment additionally provides a way to minimize communication over a remote network in performing such a process. This can be a critical consideration when one is interested in having a single computer system in a single location that users are able to connect to various locations across the world, and be able to achieve performance of the system that the user may perceive as fast and easy to use. These benefits are of particular interest to companies who wish to employ computer simulation tools for product development across technical facilities in various global locations, but wish only to build, set-up, and maintain the full suite of software on a single computer or single computer system.

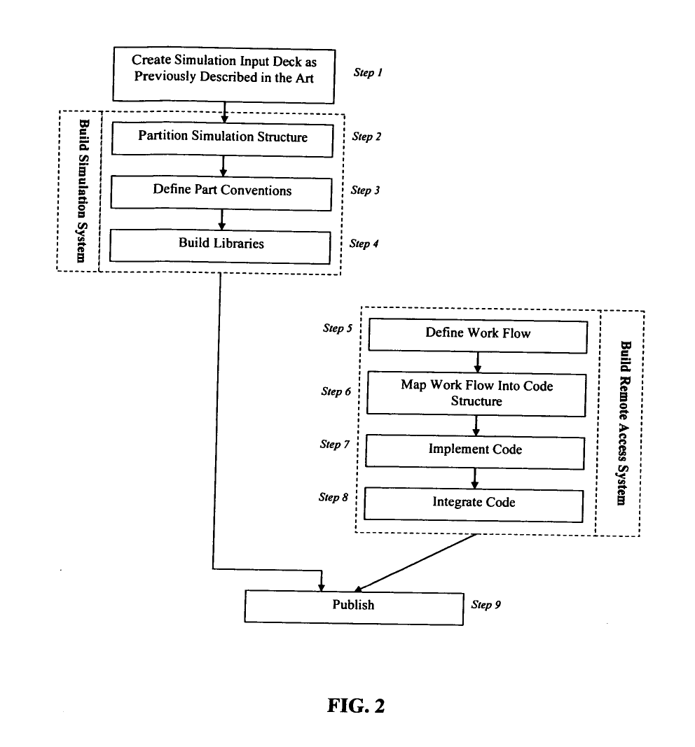

The method of the present invention as described above with respect to FIG. 1 can be improved by incorporating the steps above with a system that permits that more easily facilitates the establishment of the process described in FIG. 1. An expanded process for modeling products by use of computer aided engineering and design can be understood by following the steps discussed below in conjunction with the flowchart in FIG. 2. The flowchart in FIG. 2 describes how one skilled in the art can establish a system as described in FIG. 1 for a series of similar simulations as described below.

Step 1 of the flowchart shown in FIG. 2 comprises obtaining or creating a simulation input deck, such as by a method described above, or by using a pre-existing input deck. For efficiency, it can be important to have all of the necessary components of the simulated objects defined for the purposes of subsequent steps required to translate into a system that will allow for mass-production of input decks to be used in many simulations.

Having created a representative simulation, the next steps relate to building a simulation system. These are labeled Steps 2, 3, and 4, and are the steps that one performs for the purpose of taking the representative simulation and converting it into system by which a series of similar simulations can be run. Implicit in these operations is that knowledge must exist in what similar simulations that one wishes to conduct using this final system. For example, when one wants to simulate toothbrushes being used to brush teeth, by having a representative simulation one can understand that similar simulations would include changing toothbrush design, toothbrush material properties, hand motions, the oral anatomy, among other potential considerations. While such a plurality of simulation possibilities exist, all can fundamentally perform the same desired action of simulation of a toothbrush being used to brush teeth, and thus, they could all be considered similar simulations. In the example of a garment worn on a body, one can consider that similar simulations may consider the addition or subtraction of certain parts in the simulation. For example, considering a diaper worn on a baby, one can decide to include the impact of additional clothing, or choose to not include the impact of additional clothing. Ways to include this in the system have been previously discussed, but in either case, these can be considered similar simulations.

As can be seen with reference to FIG. 2, having constructed a representative simulation, our next step, Step 2, is to partition the simulation. Partitioning the simulation can be understood as breaking the simulation into the logical units that represent different components of the simulations that a user wishes to look at changing in the series of similar simulations. These partitions are used to define the interchangeable parts in the simulation that can be relatively quickly changed out to efficiently construct a potentially vast array of simulations. For example, in a simulation of a garment to be worn on a body, examples of interchangeable parts can include bodies of various sizes, shapes, and anatomies, garments of various sizes, shapes, and material properties, environments of various kinds, motions of the body, among other such interchangeable parts. In one embodiment, for example, a simulation for designing a sanitary napkin could include a series of similar simulations including different body anatomies, different product geometries, different body motions, and different undergarments.

Partitioning the simulation structure can be performed by creating individual files for each of the partitions, and the contents of each file could contain the simulation cards (as they are known in the art) related to that specific component in the simulation. For example, when one is interested in simulating the fit of an undergarment on a body using a structural analysis code such as ABAQUS or LS-DYNA, the simulation can be partitioned as shown below in Table 1.

TABLE 1
Partitions for Modeling Undergarment on a Body

| | Component and | |
|---|---|---|
| Partitioned | Intention of | Simulation Cards to Be |
| File | Partition | Included |
| Body File | Contains the geome- | Nodes and elements directly |
| | try (anatomy) and | related to the body, material |
| | material properties | property, section definitions, |
| | for the body of | part definitions, and |
| | interest to simulate. | potentially material damping |
| | | or hourglass control, or any |
| | | element initialized stresses |
| | | if applicable. |
| Body Motion | Contain information | Motion and curve definitions |
| File | on different body | related to motion of the body |
| | motions that the | parts or nodes as has been |
| | body could poten- | previously described in the art. |
| | tially perform. | |
| Undergarment | Contains the geome- | Nodes and elements directly |
| File | try (design), mate- | related to the undergarment, |
| | rial properties, | material property, section |
| | and motion for | definitions, part definitions, |
| | the undergarment. | and potentially material |
| | | damping or hourglass control, |
| | | or any element initialized |
| | | stresses if applicable. |
| | | Motion and curve definitions |
| | | related to motion of the |
| | | undergarment parts or nodes |
| | | so as to apply the under- |
| | | garment to the body as has |
| | | been previously described |
| | | in the art. |
| Contact | Contact interaction | Contact interaction cards and |
| File | information that | contact control cards related |
| | exists or can be | to interaction between the |
| | generated by tech- | components of the simulation. |
| | niques previously | |
| | described for | |
| | interaction between | |
| | the components of | |
| | the simulation. | |
| Control | Files required by | Examples include shell control |
| File | the simulation to | card, solid control cards, |
| | run stably, but | hourglass control cards, |
| | not directly relate | timestep control cards, and |
| | to components of | database output cards. |
| | the simulation, or | |
| | are non-physical | |
| | in nature. | |

Applying this approach, the full simulation can be constructed by using a series of commands that include each of the individual files that have been created by partitioning the simulation, or the contents of each of the individual files have been created by partitioning the simulation. Using simulation analysis software such as ABAQUS or LS-DYNA, these commands can be performed by using *INCLUDE cards as explained in the ABAQUS or LS-DYNA user manual.

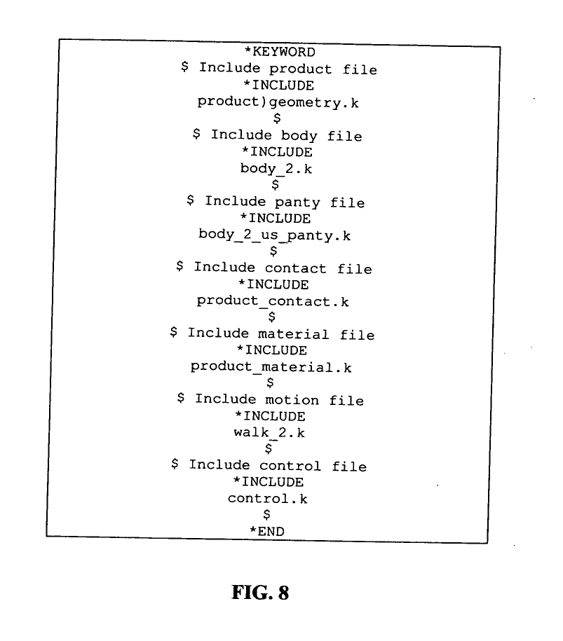

In one embodiment, all components of the simulation are partitioned so as to make the main input deck file that will be executed as simple as possible, with one example of an input deck as shown in FIG. 8 for a garment to be worn on a body. The main input deck file is the file that is used when launching the simulation analysis, and is sometime called the input file such as indicated on page I.31 of the LS-DYNA Keyword User's Manual for Version 970. Alternatively, it is understood that at least a portion of some of the files could alternatively be included in the main input deck file for equivalently the same effect. It is also understood that one could alternatively create a single file by simply taking the contents of the various partitioned files, and combining these contents together in a single file that contains all the subsequent information re-formatted in a way so as to construct a single file containing all necessary components so as to conduct the desired simulation analysis.

Having partitioned the simulation, in Step 3 of FIG. 2 the part conventions can be defined for the partitioned components of the simulation. Conventions are used to establish consistency in the simulation amongst the various, interchangeable files that will be created in a subsequent step based upon the partitioned files. Simulations can be based upon a number system in which curves, nodes, elements, parts, materials, sections, among other such cards, all require unique numbers that are assigned to each to reference them. In some cases, some codes allow one to instead assign words, letters, or other such arbitrary distinctions to identify each unique item. These conventions include consistent node numbering, consistent element numbering, consistent part ideas, consistent segment sets, and position in space. These conventions establish consistency within a given part that will subsequently be used for interchangeability. Using the partitioning example as presented above, examples of definitions of part conventions are provided below in Table 2.

TABLE 2
Part conventions

| Partitioned | |
|---|---|
| File | Convention Examples |
| Body File | All body nodes are 0-200,000; All body |
| | elements are 0-200,000; Body surface fat |
| | is part 4; Bodyfit muscle is part 5; |
| | External body surface is part 15; All |
| | body materials are 0-100; All body |
| | section definitions are 0-100; Part set |
| | or segment set 100 used to define all |
| | parts/surface of the body involved in |
| | contact |
| Body Motion | All body motion curves are 100-200; |
| File | |
| Undergarment | All undergarment nodes are 200,000-500,000; |
| File | All undergarment elements are 200,000-500,000; |
| | Undergarment fabric is part 101; Undergarment |
| | elastic is part 120; All undergarment motion |
| | curves are 200-300; All undergarment materials |
| | are 100-200; All undergarment section definitions |
| | are 100-200; Part set or segment set 650 used |
| | to define all parts/surface of the body involved |
| | in contact; The point at the center at the |
| | narrowest width across the product is always |
| | placed at the (0, 0, 0) coordinate |
| Contact | Single surface contact on part/segment set 100; |
| File | Single surface contact on part/segment set 650; |
| | Contact between part/segment sets 100 & 650 |
| Control | All hourglass controls are defined as 1, 2, 3, 4, |
| File | 5, 6, 7, 8 for each of the various hourglass |
| | control options. |

In defining part conventions, it can be helpful to ensure that all cards that require a unique identification number or tag to be assigned to them should be assigned in accordance with an established convention. In some cases, it can be advantageous to define conventions in accordance with ranges, as specific numbers can be more difficult to achieve. For example, ranges of nodes and elements are generally preferred, because it is possible that meshes of some body anatomies may require fewer or more nodes and elements to describe. In some embodiments, the initial spatial location of all parts should be defined. For example, in a model to simulate a sanitary napkin in an undergarment, the center of the narrowest potion of the undergarment can be placed at the coordinate (0, 0, 0). The tip of the tailbone on the body can be located at the coordinate (0, −3, 8). Consistent orientation of all objects using the same coordinate system can make the simulation and the results much more effective.

In one embodiment, conventions can also be defined to enable consistent element size across all simulation parts. For example, simulation parts can have all elements in the simulation with aspect ratios between 0.5-2.0, and element edge lengths between 0.5-4 mm. This convention can be helpful in improving the robustness as various parts of the simulation can be interchanged.

Part of the benefit of conventions is also the commonality that is provided in the subsequent analysis steps upon the completion of the simulation analysis. Benefits can thus be achieved in post-processing via employing scripts for the purposes of turning on and off certain components in the simulation based upon defined part numbers. Those skilled in the art will recognize how to construct such post-processing scripts based upon these conventions, and possible applications have been previously described above with respect to step E of FIG. 1.

Having defined the simulation partitions and defined part conventions that will be employed in the simulation, the next step, Step 4, is to construct libraries of each component part using the established conventions. For example, several body anatomies can be used as a library of body anatomies, several body motions can be constructed as a library of body motions, and several product geometries can be constructed and used in a library of geometries.

The libraries in turn can become the simulation analysis inputs that the user can select as has been previously discussed. As has been previously discussed, these libraries can be stored in several locations, including on local user computers, on a remote computer, on a remote computer that can be accessed via a database, or even accessed through a web-based access. These libraries can even be stored across several locations, and need not all reside on a single repository of such information. It is also possible that portions of these libraries can be interactively modified as has been previously discussed. It is also possible that over time, additions, modification, or even subtractions to these libraries can be made, based upon the conventions that have been established.

Once the simulation system as described above is understood, a system application referred to herein as the Remote Access System (RAS) can be used to make the simulation system available to a broad audience as an analysis session that can be initiated as previously described. This RAS can be described as a way to present a simple set of choices, options and displays to a user. The process to create a RAS can be understood with respect to Steps 5-9 in FIG. 2. Many software options exist that can be used for purposes of creating a RAS, such as ColdFusion (Macromedia Inc, San Francisco, Calif.), Active Server Pages (Microsoft Corporation, Redmond, Wash.), or EASA among others. Any one of these or other options could be used to create an effective RAS, the selection of which is usually determined by the available feature of available software options.

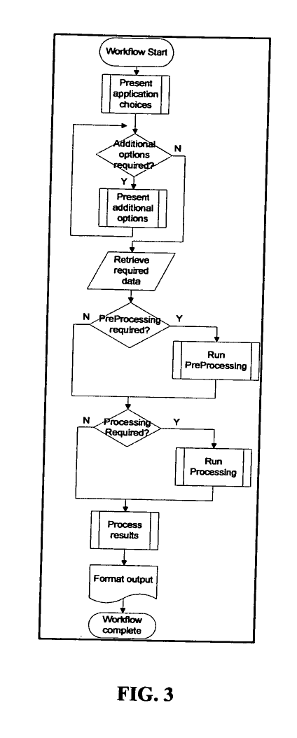

First, the work flow must be defined as indicated in Step 5 of FIG. 2. The workflow can be described as the process in which users intend to be presented with analysis input options when they have initiated an analysis session, and how they can provide analysis inputs in a quick and efficient manner so as to provide information for specific attributes for a simulation analysis that describe the specific condition they wish to conduct to evaluate a virtual product in a virtual condition by means of a simulation analysis in the analysis session. One way the workflow can be represented is in flowchart form, as one example is shown in FIG. 3 outlining the steps to present choices to a user, present additional choices based on input selections, determine data files and processing needs based on input selections and process and format results. The workflow is created by analyzing the simulation system as outlined in Steps 2-4 of FIG. 2, and mapping the partitions and necessary assembly operations to a series of steps and options that enable a user to drive the workflow to a user desired outcome. These steps are then arranged in a logical step by step order to identify where decision points exist and where additional process steps may be needed. A workflow flowchart is then documented (see, e.g., FIG. 3) to act as a guide for the design and programming effort. Those skilled in the art will readily recognize the techniques available to create a workflow through these methods.

It is possible that in building the RAS, one may wish to consider including more than one work flow in the RAS so as to facilitate a single analysis session with the potential to have multiple functionalities to conduct more than one work flow. These work flows can be related or unrelated. For example, Table 3 indicates one embodiment in which three work flows can be included in a single RAS.

TABLE 3
Multiple Work Flow Options in a Single RAS

| Work Flow | User Intended Function |
|---|---|
| Simulation & Analysis | Gather Analysis Inputs |
| | Assemble |
| | Conduct Simulation Analysis |
| | Automatically Generate Analysis Report |
| | Through Scripted, Batch Process |
| | Create Visual Representation Through |
| | Scripted, Batch Process |
| | Present Report to User as in E-mail Upon |
| | Completion of Creation of a Visual |
| | Representation |
| Analysis Only | Gather Analysis Inputs for Report |
| | Generation and Creating a Visual |
| | Representation Including Referencing Pre- |
| | Existing Simulation Analysis Results |
| | Assemble |
| | Automatically Generate Analysis Report |
| | Through Scripted, Batch Process |
| | Create Visual Representation Through |
| | Scripted, Batch Process |
| | Present Report to User as in E-mail Upon |
| | Completion of Creation of a Visual |
| | Representation |
| Simulation Only | Gather Analysis Inputs |
| | Assemble |
| | Conduct Simulation Analysis |

As part of Step 5 of FIG. 2, one can determine the analysis inputs required to complete the work flow or work flows that are to be possible to conduct within the RAS. These analysis inputs can be determined by having a discussion with at least one or more potential users and mapping the partitions as defined in Step 2 of FIG. 2 against the user's stated needs to control the process, and developing variations within the partitions that can be driven by user selections. The simulation processing needed to run the simulation and required files to enable that processing also need to be considered as potential analysis inputs that the user can control.

The analysis inputs can be represented in table form. It is also possible that analysis inputs have dependency on other analysis inputs, in which the selection of at least one or more other analysis inputs impact the selection of analysis inputs that the user prefers to be presented with in a dependent analysis input. It is also possible that some analysis inputs can be considered optional. Optional analysis inputs are analysis inputs that the user prefers to include in some situations to simulate some specific conditions, but in other situations, they prefer to exclude. Table 4 provides an example of analysis inputs determined for a simulation and analysis work flow of an absorbent feminine incontinence pad, including examples of dependent analysis inputs, including examples of their dependency relationship, and examples of optional analysis inputs.

TABLE 4
Analysis inputs for simulation and analysis
work flow of an incontinence pad

| | | | Required |
|---|---|---|---|
| Analysis | | | or |
| Input | Description | Dependency | Optional |
| Product | Preconstructed product | None | Required |
| Geometry | geometry file | | |
| File | | | |
| Body | Geometry and material | None | Required |
| | information for body | | |
| Garment | Undergarment to | Garment selections | Required |
| | be placed on the | for sizes ad style | |
| | simulated body | are dependant on | |
| | and application | chosen body as would | |
| | (motion) protocol | be appropriate for | |
| | | size and ethnicity | |
| | | of body | |
| Motion | Motion that the | Motion selections | Required |
| | body should simulate | are dependant on | |
| | | the chosen body | |
| Surface | Includes surface | Appropriate surfaces | Optional |
| | object such as a | are made available | |
| | chair or bed | only when sitting or | |
| | including geometry, | sleeping motion is | |
| | materials, and | chosen | |
| | contacts associated | | |
| | with the inclusion | | |
| | of such an object | | |
| Material | Material file that | Specific parts | Required |
| | represents the | represented in | |
| | materials in the | product geometry must | |
| | product geometry | have corresponding | |
| | file | material property | |
| | | information provided | |
| Contact | Defines contact | Specific parts | Required |
| File | amongst entities in | represented in | |
| | the simulation | simulation must have | |
| | including the | corresponding contact | |
| | product geometry | information provided | |
| | file, garment file, | as appropriate as | |
| | and body file | one skilled in the | |
| | | art can determine | |
| Pad | Select direction, | Product Geometry | Optional |
| Placement | distance and unit | File | |
| Options | to move or rotate | | |
| | the product file | | |
| | (move nodes in | | |
| | product file) from | | |
| | convention | | |
| | location | | |
| Project | Select from a list | Limited to the pre- | Required |
| Name | of projects for | determined list of | |
| | tracking purposes | projects programmed | |
| | | into the RAS | |
| File | User provides the | None | Required |
| Naming | file directory | | |
| | structure for stor- | | |
| | ing the simulation | | |
| | results on a remote | | |
| | computer | | |
| Analysis | Text field for user | None | Optional |
| Descrip- | notes on this | | |
| tion | submission | | |
| State | The time state of | Restricted to range | Required |
| Value | the simulation for | of simulation time | |
| | the analysis images | | |
| | during the report | | |
| | generation step of | | |
| Slice | The slice plane loca- | None | Required |
| Plane | tions for generating | | |
| Locations | analysis images dur- | | |
| | ing the report | | |
| | generation step of | | |

It is also possible to have inputs that the user does not provide. These inputs can be considered inherent inputs, as they are inherently required to conduct the required set of assembly operations, simulation analysis, and subsequent steps as depicted in FIG. 1. The difference between an analysis input and an inherent input is that an analysis input is provided by a user, while an inherent input is predetermined, also known as being programmed into the RAS. Therefore, since the primary determination between an analysis input and an inherent input is whether the user is able to provide the input during an analysis session, the analysis input and inherent input can be considered functionally to be very similar. In some cases, a RAS can be built with an input as an analysis input, but in a different RAS, the same input can be present as an inherent input.

The inherent inputs can be represented in table form. It is also possible that inherent inputs have dependency on analysis inputs, in which the selection of at least one or more analysis inputs can impact the inherent input. Table 5 provides an example of inherent inputs determined for a simulation and analysis work flow of a feminine hygiene incontinence pad, including examples of dependent inherent inputs, including examples of their dependency relationship.

TABLE 5
Inherent inputs for simulation and analysis
work flow of an incontinence pad

| Inherent | | |
|---|---|---|
| Input | Description | Dependency |
| Analysis | Specific version of | Hardware or related software |
| Software | the analysis software | may be dependant on specific |
| Version | program to be used in | versions of the analysis |
| | the simulation analysis | software. |
| | step of FIG. 1 | |
| Matlab | Specific version of an | Hardware or related software |
| Analysis | application (script) to | may be dependant on specific |
| Version | be executed by Matlab | version. |
| | in the report generation | |
| | step of FIG. 1 | |
| Control | File that contains | None |
| File | simulation analysis | |
| | parameters required for | |
| | stable simulation as | |
| | partitioned in Step 2 | |
| | of FIG. 2 | |
| Script | Location and version of | None |
| Location | scripts to be executed | |
| | for simulation analysis, | |
| | report generation, | |
| | assembly, or any other | |
| | steps required in | |
| Number of | The number of processors | Simulation performance may |
| Processors | to engage for this simula- | be dependant on the number |
| | tion analysis on remote | of processors used during |
| | computer cluster within | the simulation analysis |
| | limits set by the | processing and the hard- |
| | application. | ware and software systems |
| | | used to process the |
| | | simulation analysis. |
| | | Can be programmed to adapt |
| | | based on system load on |
| | | the remote computer cluster, |
| | | for example, programmat- |
| | | ically adapt to using fewer |
| | | processors when system |
| | | load is higher. |

Once the analysis inputs and inherent inputs are determined, they must also be associated with an assembly operation and a presentation format for the analysis input. The association of the assembly operations involves mapping the analysis input options that will be presented to the user in the RAS to a conversion or collection process to transform the user input into inputs used in the simulation analysis or subsequent steps of FIG. 1. One example of this is could be presenting a user with a file selection dialog where they indicate what file they want to use as an input. The assembly operation in this case could be the execution of programs necessary to copy this file from the location where the user chooses to a location that is required by the simulation and analysis code. Another example of this could be a case where the user is presented with an input selection to move the product in relation to the body. The assembly operation could be the execution of programs to modify the product files using the distance and direction input supplied by the user. Each input and inherent input can be mapped to an assembly operation that results in the creation of the simulation and analysis inputs that are meaningful to the simulation codes used to execute the simulation. Several assembly operations have been previously discussed.

It is also possible that analysis inputs and inherent inputs can be associated to actions in the simulation analysis, report generation, and subsequent steps of FIG. 1. Therefore, we more generally consider analysis inputs and inherent inputs can be associated to operations, which can include assembly operations, operations or actions performed in report generation, operations or actions performed in creating a visual representation, or operations or actions performed in presenting a report to the user.

The presentation format for an analysis input is the way in which the user will provide the analysis input during an initiated analysis session for a RAS once it has been built. Examples of presentation formats include radio buttons, pull-down lists, text boxes, among other such options commonly known in the art. Presentation formats can include options for pre-constructed analysis inputs, interactively constructed analysis inputs, and analysis inputs that are a combination of pre-constructed and interactively constructed. While many options exists for presentation formats, those skilled in the art will recognize that the decision of which presentation format can be employed can be largely influenced by user and developer preferences. One approach for determining presentation format is to create a block map of the user display to begin to organize the inputs to be presented to optimize use of available screen space, commonly known as a “wireframe”, and to choose the most appropriate presentation format as is offered by the software being used to create the RAS. While one skilled in the art would recognize many ways that this can be done, some of the principles we have found useful are:

Pieces of information that users wish to focus on an emphasis of using the system to evaluate virtual product performance should be provided by a user and stored on the user computer—this is typically the geometry and material properties of the product to be evaluated, and specific analysis operations such as the state value and slice planes mentioned in Table 4.

Pieces of information that the user knows is critical, but not a focus item—typically product evaluation context and protocols—should be presented to the user as a choice, but often times, in language that the user prefers and finds more intuitive in his or her field of expertise. For example, Body and Garment in Table 4 can be considered to be of this type.

Pieces of information that are critical to the overall workflow but not directly important to the user and how he wishes to learn about a product's performance through evaluation in a virtual environment should be de-emphasized through automation, and by use of language that makes more sense to the user. For example, the choice to make the item in Table 5 inherent inputs with which the user does not need to directly concern themselves with when providing analysis inputs during an initiated analysis session.

In some cases the input options can continue to grow over time, so dynamic drop down menus can be employed to show the most current choices without changing the initial display. In this way the user can see a consistent display each time they interact with the application but will see additional input selections in the drop down menus as they are viewed. Presentation format selections can be based on user preferences, for example to minimize horizontal scrolling and keep the presentation simple and easy to follow.

Table 6 provides several examples for analysis inputs that have been taken from Table 4, and associated with operations and presentation formats have been determined.

TABLE 6
Associated analysis operations for analysis inputs from Table 4

| Analysis | | |
|---|---|---|
| Input | Associated operation(s) | Presentation format |
| Geometry | Transfer of the file to | Use a file select on |
| File | location where it is | local computer presen- |
| | required for executing | tation as the user will |
| | simulation and analysis | need to supply this file. |
| | steps on remote computer | |
| Body | Transfer of the chosen | Use a drop down menu |
| | body file to location | format to display a |
| | where it is required for | scrollable list for |
| | executing simulation and | the user to choose. |
| | analysis steps on remote | |
| | computer | |
| Garment | Transfer of the chosen | Use a dynamic drop |
| | garment file to location | down menu format with |
| | where it is required for | a static default for |
| | executing simulation and | each body and an option |
| | analysis steps on remote | to upload a custom |
| | computer | file if needed. |
| Motion | Transfer of the chosen | Use a dynamic drop |
| | motion file to location | down menu format with |
| | where it is required for | a static default for |
| | executing simulation | each body and an option |
| | and analysis steps on | to upload a custom |
| | remote computer | file if needed. |
| Surface | Transfer of the chosen | Use a dynamic drop |
| | surface file to location | down menu format with |
| | where it is required for | a static default for |
| | executing simulation | each motion and an |
| | and analysis steps on | option to upload a |
| | remote computer | custom file. This |
| | | presentation area is |
| | | optional and will be |
| | | hidden if relevant |
| | | options do not exist |
| | | for the motion |
| | | selection. |
| Material | File Transfer of the | Use a file select on |
| | file to location where | local computer presen- |
| | it is required for | tation as the user |
| | executing simulation and | will need to supply |
| | analysis steps. | this file. |
| Contact | File Transfer of the | Use a file select on |
| File | file to location where | local computer presen- |
| | it is required for | tation as the user |
| | executing simulation and | will need to supply |
| | analysis steps. | this file. |
| Pad | Use values provided by | Use Radio buttons to |
| Placement | user as analysis inputs | present obvious direc- |
| Options | and convert into dis- | tion choices to user |
| | placement vector. Use a | with input boxes to enter |
| | program to displace the | the specific distance. |
| | nodes in the product | Also show a drop down |
| | geometry file by this | menu with optional |
| | vector. Recreate the | measurement units so |
| | product geometry file in | the user can specify |
| | the displaced location. | the distance in unit |
| | Repeat for rotation as | they are most comfort- |
| | required. | able with. The input |
| | | boxes and unit selec- |
| | | tion should be suppressed |
| | | until the user indicates |
| | | they want to move the pad |
| | | by choosing one of the |
| | | radio buttons. |
| Project | Capture the chosen | Use a dynamic drop down |
| Name | Project Name for use | menu format to show the |
| | in tracking. | user all project names. |
| File | Create directory in | Text box to collect |
| Naming | user account on remote | freeform text to describe |
| | computer. New directory | the nature of this |
| | is created with the name | simulation in the users |
| | as the user provided as | own words. |
| | an analysis input. | |
| Analysis | Capture text description | Text box to collect |
| Description | into a variable for use | freeform text to describe |
| | in the results display | the nature of this |
| | as an identifier. | simulation in the users |
| | | own words. |
| State | Replace variable in | Numeric input box that |
| Value | script used in report | is initially populated |
| | generation step of FIG. | with the predetermined |
| | 1 by post-processing | default value. The user |
| | software to generate | can use the default or |
| | images from state | overwrite it. |
| | specified in analysis | |
| | input. | |
| Slice | Replace variables in | Numeric input boxes that |
| Plane | script used in report | are initially populated |
| Locations | generation step of FIG. | with the predetermined |
| | 1 by post-processing | default values. The user |
| | software to generate | can use the default or |
| | images from specified | overwrite it. |
| | slice plane locations | |
| | in analysis input. | |

Table 7 provides several examples for inherent inputs that have been taken from Table 5, and associated with operations.

TABLE 7
Associated analysis operations for inherent inputs from Table 5

| Inherent Input | Associated operation(s) |
|---|---|
| Analysis Software | Simulation analysis step as in |
| Version | FIG. 1 is executed with specified |
| | version of analysis software, |
| Matlab Analysis | Use of Matlab in report generation |
| Version | step as in FIG. 1 is executed with |
| | specified version of Matlab analysis |
| | application, |
| Control File | Transfer of the specified control |
| | file to location where it is required |
| | for executing simulation and analysis |
| | steps on remote computer |
| Script Location | Transfer of the specified scripts |
| | to location where they are required |
| | for executing appropriate steps on |
| | remote computer as corresponding |
| | to FIG. 1 |
| Number of | Simulation analysis step as in |
| Processors | FIG. 1 is executed with |
| | specified number of processors, |

Having defined the workflow, the next step is to map the work flow into code structure (see FIG. 2, Step 6). In one embodiment, we map the work flow into the code structure of a web application. However, other applications can be used such as FORTAN programs, C++ programs, Java code, Visual Basic, Python or other commercial programming languages, possibly in conjunction with an application like ABAQUS CAE, among other such applications known in the art for having the capability to support a mapped work flow in a code structure. A web application can deliver the displays to the user and process the inputs from the user as well as manage the workflow processing to complete the simulation and creation of outputs. Examples of commercially available web application development tools include Active Server Pages from Microsoft (Microsoft Corporation, Redmond, Wash.) or EASA.

During the step of mapping the work flow into code structure, one can design the displays and navigation scheme to present choices to the user. One could design the displays in such a way that selection of some choices could cause the display to change to show or hide other choices in the display. Part of this process involves the design and creation of data repositories. Examples of data repositories include simple flat files, indexed files, or databases. These data repositories can be created in a way that they can be updated independent of the RAS application to be read by the RAS application when presenting the user with input options. In this way the application code does not need to be updated each time a new input selection is to be shown to the user. One example of this includes the creation of a repository of available bodies to use in a simulation and analysis execution for garment fit analysis. The body input selection could be coded to look up the available body choices in the data repository and then format them to be presented to the user. The presentation for selecting the body can be programmed into the application, but the selection options are dynamically generated by the code through interrogation of the data in the body data repository. Additional information could be stored along with the body choices in the repository that could be used to identify the file names for the specified body. These repositories can be used to store a variety of information needed by the simulation analysis and subsequent steps. A database with garment options and associated files names, a database with information about available software versions or a data repository with available product geometry files and associated information are a few examples.

In addition to the displays and navigation, the work flow steps can be mapped to complete the assembly operations to transform the user selected analysis inputs into the simulation analysis inputs format required by the simulation programs. The assembly operations might be simple file transfer operations, C-shell scripts for manipulating files or calling pre-coded software routines, program calls to pre-coded functions or other calls to software routines as known in the art. Each input presented to the user and implied by the RAS can require some action which has been referred to as an assembly operation. One example of an assembly operation could be assigning values to a series of variables based on the selection chosen by the user from the analysis input selections. These variables could then be used to substitute values in scripts or input files in a subsequent step. A more complex example of an assembly step could be described as assigning values to a set of variables and program flags which then cause execution of conditional programming steps based on the program flag values. In one such example, the selection of a sanitary pad placement direction causes variables and program flags to be set which will cause the conditional execution of programming steps that copy the input geometry file, execute code to change the geometry file based on the input selections and then replaces and renames the original file. In yet another example an assembly operation launches a C-shell script with variable values that executes a series of steps to copy files to a specific location and then interrogates the success of these steps to notify the next step of the outcome. In this way we construct a series of assembly steps that execute based on user selected inputs and conditional values set by previous steps. This allows each execution of the assembly operations to be unique based on the user selected inputs and results of the execution of each step.

Once the work flow has been mapped into a code structure, the code can be implemented (FIG. 2, Step 7). The implementation of the application code can be considered the work required to develop the scripts, programs, application, software, compiled programs, and other such devices for the purposes of executing the assembly operations, simulation analysis, report generation, visual representation, and reporting back to the user. Each script, program, application, software, compiled program or other such device implements developed for these purposes can be considered a supporting code. Examples of supporting code include shell scripts, compiled program, such as C++ or Fortran, scripts that operate or are executed by a program, such as Python scripting of ABAQUS CAE, or LSPrePost scripts to execute report generation with LSPrePost, simulation analysis software such as FLUENT, ABAQUS, and LS-DYNA, among other such software. Supporting code can also include scripting such as C shell or batch files for the purpose of making the execution simple and repeatable on a remote computer while potentially eliminating any need for direct user interaction. Scripting can also cause batch execution of tools that might normally run interactively so as to automate the execution of tools without requiring direct user interaction.

As previously described, the series of analysis inputs and inherent inputs have been related to assembly operations and subsequent steps. In doing so, these relationships can prescribe certain actions to occur within the RAS.

It is also possible that several supporting codes can be used to create the intended action of a single operation. It is also possible that several actions can also be performed within a single supporting code. One could also split the steps into small code subcomponents such that each subcomponent could execute independent of the other subcomponents. Such an approach could be used to manage the running of many parallel executions of such code.

After implementing the code, the next step is to integrate the code as in FIG. 2, Step 8. Integrating the code is the process by which the RAS is constructed, or programmed so as to execute each step in the workflow, or workflows, contained within a RAS as a sequence of events driven by the analysis inputs. In Step 5 of FIG. 2, workflow was defined and software was selected to be used as the RAS. Step 8 of FIG. 2 is the point at which the RAS is programmed in the software of choice, based upon the workflow that has been defined, and mapped into code structure, in addition to integrating the supporting code that has been implemented in the previous step, Step 7 of FIG. 2. One can program in the RAS the workflow or workflows to be executed within the RAS during an initiated analysis session. For example, when using EASA, as in the embodiment, the EASA manual readily explains how such operations can be programmed.

The final step of FIG. 2, Step 9, is publishing. Publishing could best be described as the process to take the RAS, supporting code and all components and make them available to the general audience. The step of publishing makes the final RAS available to users as an analysis session that they can choose to implement, as indicated in step A of FIG: 1.

Publishing can be accomplished by means according to and dependent on the software used to create the RAS. For example, publishing could entail creating a URL that is available for users to access and initiate an analysis session. With different software, publishing can be accomplished by placing an application on a remote computer that can be directly accessed by a user computer to initiate an analysis session. In another example, publishing can be accomplished by tools provided within a software application, such as executing a “publish” command as in EASA.

One approach to publishing could involve what is known in the art as version control where the code is assigned a version and release number so as to identify the version of the code and preserve previous versions of the code for future reference. Using this approach one could enable a process whereby the application could revert back to an older version should some unforeseen problems occur with the application after it has been published. For example, one could track a version history of the application code so as to see the code change activity and progression over time.

It is also possible that many RAS can be created, so as to present the users with a choice of at least one or more analysis sessions that may be initiated, potentially for a variety of tasks. Also, a variety of systems could exist, including different computers from which analysis sessions can be initiated, different software used to implement each analysis session, different supporting code, among many other such choices.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for modeling design of products, the method comprising:
g. providing a user with a computer, the computer having software capability locally or remotely accessible to do the following:
i. analyze one or more analysis inputs;
ii. assemble said inputs for analysis;
iii. perform a simulation analysis;
iv. generate a report;
h. initiating an analysis session on said computer;
i. selecting one or more analysis inputs;
j. assembling said analysis inputs;
k. running an analysis;
l. generating a report of said analysis.

2. The method of claim 1, wherein said analysis inputs are selected from the group consisting of pre-constructed, interactively constructed, and a combination thereof.

3. The method of claim 1, wherein said analysis inputs define the geometry of a garment.

4. The method of claim 1, wherein said analysis inputs define the geometry of a human body.

5. The method of claim 1, wherein said analysis is a simulation analysis.

6. The method of claim 1, further providing a remote computer, and wherein said analysis is a simulation analysis run on said remote computer.

7. The method of claim 1, wherein said report comprises files selected from the group consisting of, images, charts, graphs and text documents.

8. The method of claim 1, wherein said report comprises three-dimensional images.

9. The method of claim 1, comprising a host computer wherein said software capability resides, said host computer being linked via the internet to said user's computer.

10. A method for modeling design of products, the method comprising:
a. providing a user with a computer, the computer having software capability locally or remotely accessible to do the following:
i. analyze one or more analysis inputs;
ii. assemble said inputs for analysis;
iii. perform a simulation analysis;
iv. generate a report;
b. providing an input deck for simulation analysis;
c. building a simulation system in a method comprising the steps of:
i. partitioning a simulation structure from said input deck;
ii. defining part conventions;
iii. building libraries;
d. building remote access system in a method comprising the steps of:
i. defining a work flow;
ii. mapping the work flow into a code structure;
iii. implementing the code;
iv. integrating the code;
e. publishing the outcome of all above steps.

11. The method of claim 10, wherein said partitioning step creates partitions comprising interchangeable parts in the simulation.

12. The method of claim 11, wherein said interchangeable parts include parts selected from the group consisting of: size, shape, anatomy, material properties, and environment.

13. The method of claim 10, wherein said part conventions comprise unique reference numbers.

14. The method of claim 10, wherein said libraries comprise libraries selected from the group consisting of body anatomies, body motions product geometries, and product types.

15. The method of claim 10, where said work flow comprises multiple functionalities.

16. The method of claim 10, wherein said work flow step comprises choosing among input options.

17. The method of claim 16, wherein said input options are presented to a user via drop down menus.

18. The method of claim 10, wherein said step of mapping the work flow into code structure comprises design and creation of data repositories.

19. The method of claim 18, wherein said data repositories comprise flat files, indexed files, or databases.

20. The method of claim 10, wherein said implementing step results in scripts, programs, applications, software, or compiled programs for executing assembly operations, simulation analyses, report generation, or visual representation.

21. The method of claim 10, wherein said publishing step comprises creating a URL that is available for users to access and initiate an analysis session.
